(19) United States
(12) Patent Application Publication
(10) Pub. No.: US 2023/0069908 A1
(43) Pub. Date: Mar. 9, 2023

(54) RECOGNITION APPARATUS, LEARNING APPARATUS, METHODS AND PROGRAMS FOR THE SAME

(71) Applicant: NIPPON TELEGRAPH AND TELEPHONE CORPORATION, Tokyo (JP)

(72) Inventors: Atsushi ANDO, Tokyo (JP); Yuki KITAGISHI, Tokyo (JP); Hosana KAMIYAMA, Tokyo (JP); Takeshi MORI, Tokyo (JP)

(73) Assignee: NIPPON TELEGRAPH AND TELEPHONE CORPORATION, Tokyo (JP)

(21) Appl. No.: 17/799,623

(22) PCT Filed: Feb. 21, 2020
(86) PCT No.: PCT/JP2020/006959

§ 371 Date: Aug. 12, 2022

(51) Int. Cl. G10L 15/16; G10L 15/02; G10L 15/06; G10L 15/22

(52) U.S. Cl. CPC G10L 15/16; G10L 15/02; G10L 15/063; G10L 15/22

(57) ABSTRACT

A recognition apparatus includes a classification unit that estimates a non-linguistic and para-linguistic information label to be imparted by an n-th listener from an acoustic feature amount of speech data to be recognized using an n-th classification model, and an integration unit that integrates estimation results of the non-linguistic and para-linguistic information labels for N listeners and obtains non-linguistic and para-linguistic information estimation results as a recognition apparatus for the speech data to be recognized, and the n-th classification model is a classification model trained using training speech data and a non-linguistic and para-linguistic information label imparted to the training speech data by the n-th listener as training data.

### TECHNICAL FIELD

The present invention relates to a technology for recognizing non-linguistic and para-linguistic information from an utterance.

### BACKGROUND ART

Automatic estimation of non-linguistic and para-linguistic information from an utterance is required. Non-linguistic and para-linguistic information is information that is not linguistic information among information contained in speech. Non-linguistic information is information that cannot be changed at will, such as physical features and emotions. Para-linguistic information is information that can be changed at will, such as intention and attitude. For example, when an emotion (ordinary state, pleasure, anger, and sadness) of a speaker can be automatically estimated from an utterance, an application to, for example, a simple mental check in a workplace is possible. Further, when drowsiness of the speaker can be automatically estimated from the utterance, it is possible to prevent dangerous driving at the time of driving of a car. Hereinafter, a technology of receiving a certain utterance (speech data) as an input and classifying non-linguistic and para-linguistic information contained in the utterance into a finite number of classes (for example, four classes including an ordinary state, pleasure, anger, and sadness) is called non-linguistic and para-linguistic information recognition.

NPL 1 has been proposed as a related art of a non-linguistic and para-linguistic information recognition technology. In NPL 1, to be recognized is emotion, and classification into four classes from an utterance is performed. The recognition apparatus receives an acoustic feature in each short time extracted from an utterance (for example, Mel-Frequency Cepstral Coefficient: MFCC) or a signal waveform of the utterance itself as an input, and uses a classification model based on deep learning as a non-linguistic and para-linguistic information classification model. The classification model based on deep learning is configured of a time-series model layer and a fully connected layer. A convolutional neural network layer and a self-attention mechanism layer are combined in the time-series model layer so that non-linguistic and para-linguistic information recognition focusing on information in a specific section in the utterance is realized. For example, focusing on the fact that a voice becomes extremely high at an end of speech, it is possible to estimate that the utterance falls into the anger class.

For training of the non-linguistic and para-linguistic information classification model, a set of training input utterance data (training speech data) and a correct answer label is used. However, because the non-linguistic and para-linguistic information is subjective information, it is very difficult to define the correct answer label. For example, in the four classes including an ordinary state, pleasure, anger, and sadness, it is not appropriate for the speaker to be caused to give the correct answer label. For example, this is because the criteria for determining an ordinary state, pleasure, anger, and sadness differ from speaker to speaker. Further, even when a third party listening to the utterance gives the correct answer label, there is concern that the correct answer label will change each time the third party changes. For this reason, in many previous studies, a plurality of listeners were prepared, and the having-the-greatest-number labels, which were non-linguistic and para-linguistic information labels imparted by the greatest number of listeners, were defined as correct answer labels.

### CITATION LIST

### Non Patent Literature

[NPL 1] Lorenzo Tarantino, Philip N. Garner, Alexandros Lazaridis, “Self-attention for Speech Emotion Recognition”, INTERSPEECH, pp. 2578-2582, 2019.

### SUMMARY OF THE INVENTION

### Technical Problem

As described above, determination criteria for the non-linguistic and para-linguistic information label may differ for each listener. For example, some listeners easily determine that a certain utterance is the ordinary state class when the listeners listen to the utterance, while others easily determine that the utterance is the pleasure class. However, because the non-linguistic and para-linguistic information labels of many listeners are integrated in the having-the-greatest-number labels, the determination criteria the having-the-greatest-number labels differ for each utterance, causing complication. Therefore, when the non-linguistic and para-linguistic information classification model is trained using the having-the-greatest-number labels as the correct answer labels as in the related art, there is concern that it will be difficult to estimate the non-linguistic and para-linguistic information.

A specific example is illustrated in FIG. 1. Classes to be recognized include the four classes including an ordinary state, pleasure, anger, and sadness. The having-the-greatest-number label is pleasure in utterance 3, and the having-the-greatest-number label is determined based on determination criteria of listeners A, B, C, and D. On the other hand, the having-the-greatest-number labels are pleasure in utterance 1 and sadness in utterance 2, but the having-the-greatest-number labels are determined based on the determination criteria of listeners A and B in utterance 1 and the determination criteria of listeners C and D in utterance 2. That is, the determination criteria for the having-the-greatest-number labels differ between utterance 1 and utterance 2. In this example, listeners A and B tend to have a preference to determine pleasure, and the determination criteria determining the labels are regular for one listener. However, in the case of the having-the-greatest-number labels, which listener determines the label differs for each utterance, and the determination criteria for the label are complicated.

An object of the present invention is to provide a recognition apparatus that avoids use of a complicated correct answer label and estimates non-linguistic and para-linguistic information with higher accuracy than the related art, a training apparatus that trains a model used for recognition, methods thereof, and a program.

### Means for Solving the Problem

In order to solve the above problem, according to an aspect of the present invention, a recognition apparatus includes: a classification unit configured to estimate a non-linguistic and para-linguistic information label to be imparted by an n-th listener from an acoustic feature amount of speech data to be recognized using an n-th classification model; and an integration unit configured to integrate estimation results of the non-linguistic and para-linguistic information labels for N listeners and obtain non-linguistic and para-linguistic information estimation results as a recognition apparatus for the speech data to be recognized, wherein the n-th classification model is a classification model trained using training speech data and a non-linguistic and para-linguistic information label imparted to the training speech data by the n-th listener as training data.

In order to solve the above problem, according to another aspect of the present invention, a recognition apparatus includes: a classification unit configured to estimate a non-linguistic and para-linguistic information label to be imparted by an n-th listener from a listener code indicating the n-th listener and an acoustic feature amount of speech data to be recognized using a classification model; and an integration unit configured to integrate estimation results of the non-linguistic and para-linguistic information labels for N listeners and obtain non-linguistic and para-linguistic information estimation results as a recognition apparatus for the speech data to be recognized, wherein the classification model is a classification model trained using training speech data, the listener code indicating the n-th listener, and a non-linguistic and para-linguistic information label imparted to the training speech data by the n-th listener as training data.

In order to solve the above problem, according to another aspect of the present invention, a training apparatus includes: a non-linguistic and para-linguistic information classification model training unit configured to train a para-linguistic information classification model using a listener code from an acoustic feature sequence of training speech data, a non-linguistic and para-linguistic information label imparted to the training speech data by a listener n, and the listener code being information indicating the listener n, wherein the para-linguistic information classification model using the listener code is a model for estimating a non-linguistic and para-linguistic information label to be imparted to the speech data by the listener corresponding to the listener code from the acoustic feature sequence corresponding to the speech data and the listener code.

### Effects of the Invention

According to the present invention, an effect that it is possible to estimate non-linguistic and para-linguistic information with higher accuracy than the related art is achieved.

### BRIEF DESCRIPTION OF DRAWINGS

FIG. 1 is a diagram illustrating having-the-greatest-number labels.

FIG. 2 is a functional block diagram of a training apparatus according to a first embodiment.

FIG. 3 is a diagram illustrating an example of a processing flow of the training apparatus according to first and second embodiments.

FIG. 4 is a functional block diagram of a recognition apparatus according to the first embodiment.

FIG. 5 is a diagram illustrating an example of a processing flow of the recognition apparatus according to the first and second embodiments.

FIG. 6 is a functional block diagram of a training apparatus according to the second embodiment.

FIG. 7 is a diagram illustrating a structure of a para-linguistic information classification model using a listener code.

FIG. 8 is a functional block diagram of a recognition apparatus according to the second embodiment.

FIG. 9 is a diagram illustrating a configuration example of a computer to which the present scheme is applied.

### DESCRIPTION OF EMBODIMENTS

Hereinafter, embodiments of the present invention will be described. In the drawings used in the following description, components having the same functions and steps of performing the same processing are denoted by the same reference signs, and repeated description is omitted.

### Points of First Embodiment

A point of the present embodiment is not that a non-linguistic and para-linguistic information classification model for directly estimating the having-the-greatest-number labels as in a scheme of the related art is trained. The point of the present embodiment is that after a classification model is trained so that the non-linguistic and para-linguistic information label for each listener is estimated, estimation results of the classification model are integrated, and a non-linguistic and para-linguistic information label in which estimation results of all listeners are taken into account is estimated.

As described above, the determination criteria for non-linguistic and para-linguistic information labels are regular in the same listener. Therefore, it is conceivable that estimation of the non-linguistic and para-linguistic information label for each listener is easier than estimation of the having-the-greatest-number labels. Based on this, the training apparatus is caused to train as many non-linguistic and para-linguistic information classification models as the number of listeners in order to estimate the non-linguistic and para-linguistic information label for each listener, the classification model for each listener is used to cause the training apparatus to estimate the non-linguistic and para-linguistic information label for each listener, and estimation results are integrated in order for the recognition apparatus to estimate the non-linguistic and para-linguistic information label as the recognition apparatus. With such a configuration, estimation accuracy of the non-linguistic and para-linguistic information label for each listener is improved, and thus, in a non-linguistic and para-linguistic information recognition system according to the present embodiment, it is possible to estimate the non-linguistic and para-linguistic information label with higher accuracy than the estimation using the non-linguistic and para-linguistic information classification model train by using the having-the-greatest-number labels directly.

### First Embodiment

The non-linguistic and para-linguistic information recognition system includes a training apparatus 100 and a recognition apparatus 200.

The training apparatus 100 receives a combination of training input utterance data and a non-linguistic and para-linguistic information label (correct answer label) for each listener corresponding to the training input utterance data as an input, trains a non-linguistic and para-linguistic information classification model for each listener, and outputs a result. Hereinafter, it is assumed that the number of listeners is N, and N non-linguistic and para-linguistic information classification models are trained. Here, N is any integer equal to or greater than 2. It is assumed that a large number of combinations of training input utterance data and a correct answer label are prepared prior to training.

The recognition apparatus 200 receives the non-linguistic and para-linguistic information classification model for each listener prior to recognition processing. The recognition apparatus 200 receives the input utterance data to be recognized (speech data to be recognized) as an input, uses the non-linguistic and para-linguistic information classification model for each listener to estimate the non-linguistic and para-linguistic information label as the recognition apparatus 200, and outputs an estimation result.

The training apparatus and the recognition apparatus are special devices configured by loading a special program into a known or dedicated computer having, for example, a central processing unit (CPU), a main storage device (a random access memory (RAM)), and the like. The training apparatus and the recognition apparatus execute each process under the control of the central processing unit, for example. Data input to the training apparatus and the recognition apparatus or data obtained by each process are stored in the main storage device, for example, and the data stored in the main storage device is read into the central processing unit as necessary and used for other processing. Processing units of the training apparatus and the recognition apparatus may be at least partially configured by hardware such as an integrated circuit. Each of storage units included in the training apparatus and the recognition apparatus can be configured of, for example, a main storage device such as a random access memory (RAM) or middleware such as a relational database or a key-value store. However, each storage unit does not necessarily have to be included inside the training apparatus and the recognition apparatus, and may be configured of an auxiliary storage device configured of a semiconductor memory element such as a hard disk, an optical disc, or a flash memory or may be configured to be included outside the training apparatus and the recognition apparatus.

First, the training apparatus 100 will be described.

### Training Apparatus 100

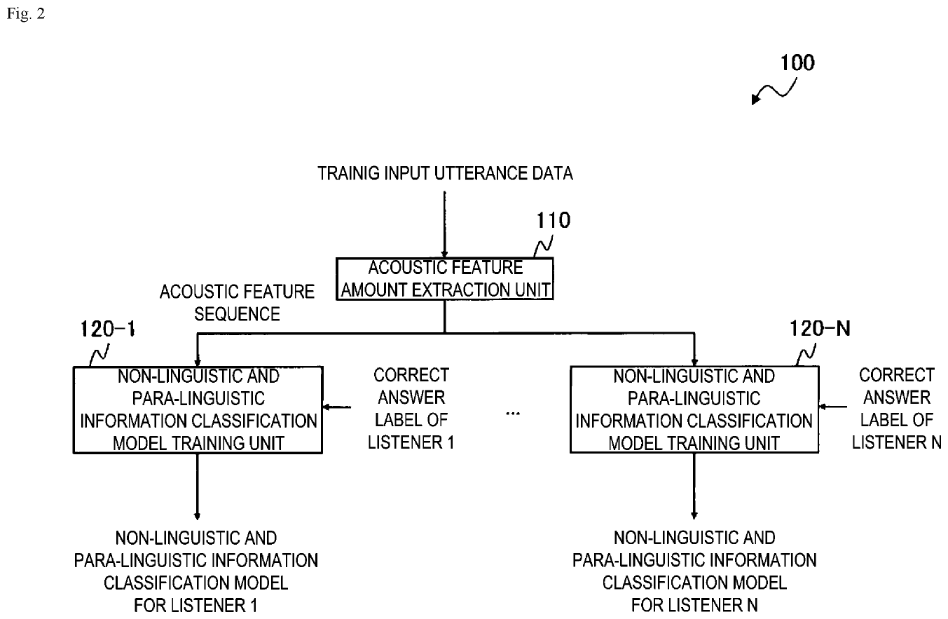

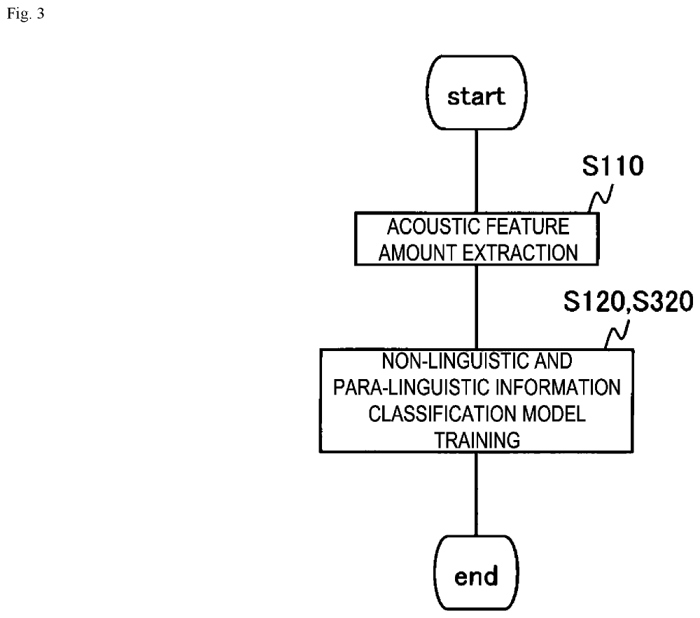

FIG. 2 illustrates a functional block diagram of the training apparatus 100 according to the first embodiment, and FIG. 3 illustrates a processing flow thereof.

The training apparatus 100 includes an acoustic feature amount extraction unit 110 and N non-linguistic and para-linguistic information classification model training units 120-n. Here, n=1, 2, . . . , N.

First, a large number of combinations of training input utterance data and the non-linguistic and para-linguistic information label for each listener corresponding to the training input utterance data are prepared.

Then, the training apparatus 100 trains as many non-linguistic and para-linguistic information classification models as the number of listeners in order to estimate the non-linguistic and para-linguistic information label for each listener. A model training method is the same as the related art, but in the related art, having-the-greatest-number labels are trained as correct answer labels, whereas in the present embodiment, the non-linguistic and para-linguistic information label for each listener is trained as the correct answer label.

Each of the units will be described below.

### Acoustic Feature Amount Extraction Unit 110

Input: Training input utterance data
Output: Acoustic feature sequence

The acoustic feature amount extraction unit 110 extracts an acoustic feature sequence from the training input utterance data(S110). The acoustic feature sequence is a sequence in which utterance data is divided by a short-time window, an acoustic feature is obtained for each short-time window, and vectors of the acoustic features are arranged in chronological order. For example, the acoustic features include one or more of a logarithmic power spectrum, a logarithmic filter bank, an MFCC, a fundamental frequency, a logarithmic power, a harmonics-to-noise ratio (HNR), a speech probability, the number of zero intersections, and a first or second order derivative thereof. The speech probability is obtained, for example, from a likelihood ratio of a pre-trained speech/non-speech GMM model. The HNR is obtained, for example, through a scheme based on cepstrum (Reference 1). When more acoustic features are used, various features included in the utterance can be expressed, and emotion recognition accuracy tends to improve.

### (Reference 1) Peter Murphy, Olatunji Akande, “Cepstrum-Based Harmonics-to-Noise Ratio Measurement in Voiced Speech,” Lecture Notes in Artificial Intelligence, Nonlinear Speech Modeling and Applications, Vol. 3445, Springer-Verlag, 2005.

### Non-linguistic and Para-linguistic Information Classification Model Training Unit 120-n

Input: Acoustic feature sequence, and non-linguistic and para-linguistic information label of listener n (correct answer label)
Output: Non-linguistic and para-linguistic information classification model of listener n

The non-linguistic and para-linguistic information classification model training unit 120-n sets the acoustic feature sequence of the training input utterance data and the non-linguistic and para-linguistic information label (correct answer label) imparted to the training input utterance data by the listener n as training data, and trains the non-linguistic and para-linguistic information classification model of listener n (S120). The non-linguistic and para-linguistic information classification model of listener n is a model for estimating the non-linguistic and para-linguistic information label that is imparted to the utterance data by the listener n from the acoustic feature sequence corresponding to the utterance data. Listener n is the n-th listener. In the training of the present model, an acoustic feature sequence of a certain utterance and non-linguistic and para-linguistic information labels of listener n corresponding to the utterance are set as one set, and a large number of sets are used. As many non-linguistic and para-linguistic information classification models as the number of listeners are trained in order to estimate the non-linguistic and para-linguistic information label for each listener. The related art may be used as the model training method. However, in the related art, the having-the-greatest-number labels are trained as correct answer labels, whereas in the present invention, the non-linguistic and para-linguistic information label for each listener is trained as the correct answer label.

In the present embodiment, the classification model based on deep learning similar to the related art may be used. That is, a classification model configured of a time-series model layer and a fully connected layer may be used. A stochastic gradient descent method in which a set of an acoustic feature sequence and a non-linguistic and para-linguistic information label of listener n is used for several utterances, and an error back propagation method is applied to loss functions thereof and used to update model parameters.

With the above configuration, N non-linguistic and para-linguistic information classification models of listeners n are trained and acquired. Although, in the present embodiment, a case in which the recognition apparatus 200 includes N non-linguistic and para-linguistic information classification model training units 120-n has been described, one non-linguistic and para-linguistic information classification model training unit may be included and the same processing may be performed, or the acoustic feature sequence and the non-linguistic and para-linguistic information label of listener n (n=1, 2, . . . , N) may be received as an input, and the non-linguistic and para-linguistic information classification model for each listener may be trained.

Next, the recognition apparatus 200 will be described.

### Recognition Apparatus 200

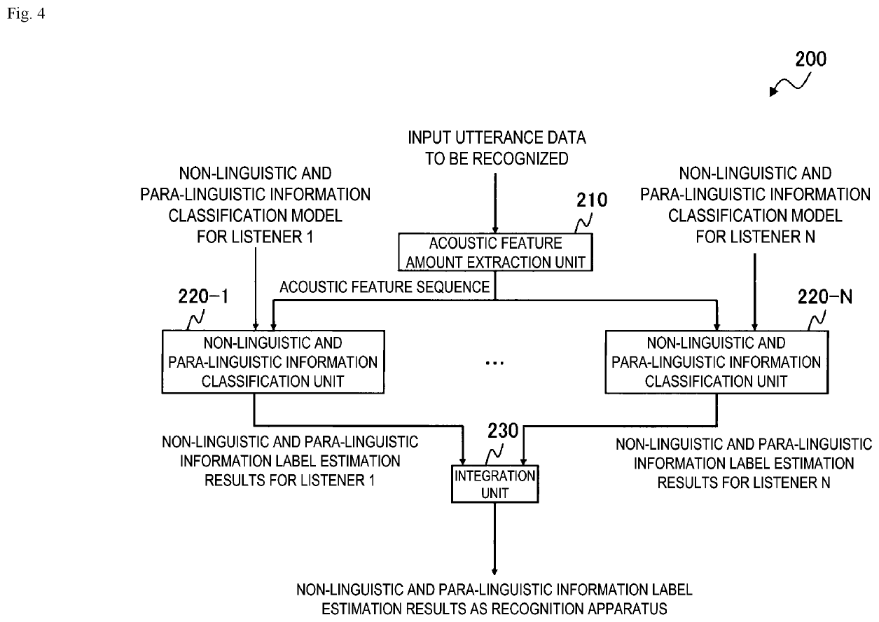

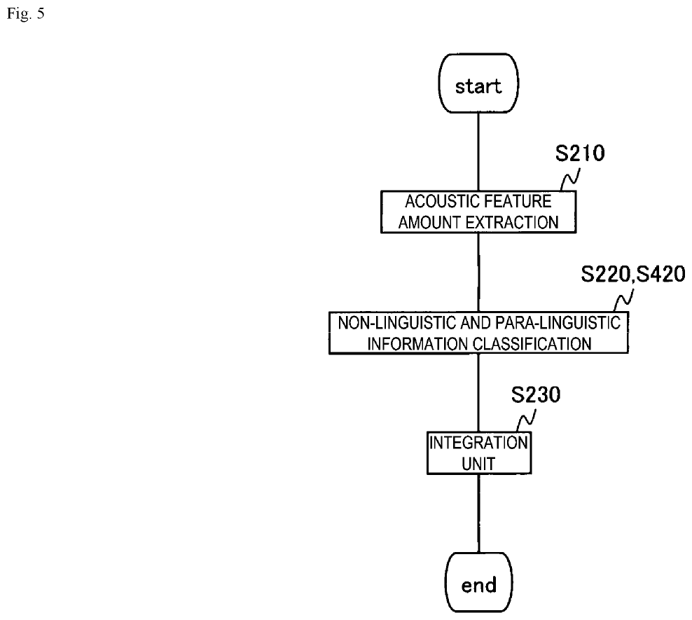

FIG. 4 illustrates a functional block diagram of the recognition apparatus 200 according to the first embodiment, and FIG. 5 illustrates a processing flow thereof.

The recognition apparatus 200 includes an acoustic feature amount extraction unit 210, N non-linguistic and para-linguistic information classification units 220-n, and an estimation result integration unit 230.

The recognition apparatus 200 inputs the input utterance data to be recognized to the non-linguistic and para-linguistic information classification model for each listener trained by the training apparatus 100, and obtains a non-linguistic and para-linguistic information recognition results for each listener.

Then, the recognition apparatus 200 integrates the non-linguistic and para-linguistic information recognition results for respective listeners, and obtains the non-linguistic and para-linguistic information recognition results as the recognition apparatus. In the integration method, for example, a class taking a largest value among average values of posterior probabilities of the non-linguistic and para-linguistic information labels output by the non-linguistic and para-linguistic information classification model is regarded as the non-linguistic and para-linguistic information recognition result.

Hereinafter, each of the units will be described.

### Acoustic Feature Amount Extraction Unit 210

Input: Input utterance data to be recognized
Output: Acoustic feature sequence

The acoustic feature amount extraction unit 210 extracts the acoustic feature sequence from the input utterance data to be recognized (S110). The same extraction method as that of the acoustic feature amount extraction unit 110 may be used.

### Non-linguistic and Para-linguistic Information Classification Unit 220-n

Input: Acoustic feature sequence, and non-linguistic and para-linguistic information classification model of listener n
Output: Non-linguistic and para-linguistic information label estimation result of listener n

The non-linguistic and para-linguistic information classification unit 220-n uses the non-linguistic and para-linguistic information classification model of listener n to estimate the non-linguistic and para-linguistic information label imparted by the listener n from the acoustic feature sequence of the input utterance data to be recognized (S220).

For example, a non-linguistic and para-linguistic information label estimation result p(n) of listener n includes a posterior probability p(n, t) for each non-linguistic and para-linguistic information label t obtained by forward propagating the acoustic feature sequence to the non-linguistic and para-linguistic information classification model of listener n. p(n)=(p(n, 1), p(n, 2), . . . , p(n, T)), T is a total number of types of non-linguistic and para-linguistic information labels, and t=1, 2, . . . , T.

### Estimation Result Integration Unit 230

Input: Non-linguistic and para-linguistic information label estimation results of N listeners n
Output: Non-linguistic and para-linguistic information label estimation results of recognition apparatus 200

The estimation result integration unit 230 integrates the non-linguistic and para-linguistic information label estimation result for each of the N listeners, and obtains the non-linguistic and para-linguistic information label estimation results of the recognition apparatus 200 for the input utterance data to be recognized (S230). For example, the non-linguistic and para-linguistic information label estimation results of the recognition apparatus 200 are that:

(1) the posterior probability p(n, t) is averaged for each non-linguistic and para-linguistic information label t, and T average posterior probabilities

$${p}_{ave} ( t ) = \frac{p ( 1 , t ) + p ( 2 , t ) + … + p ( N , t )}{N} \qquad [ Math . 1 ]$$

are obtained, and are obtained as a non-linguistic and para-linguistic information label corresponding to a maximum average posterior probability among T average posterior probability Pₐᵥₑ(t), or

(2) the non-linguistic and para-linguistic information label in which the posterior probability p(n, t) is a maximal one for each listener n

$${Label}_{max} ( n ) {←}_{t} arg max ( p ( n , t ) ) \qquad [ Math . 2 ]$$

is obtained, and is obtained as the most common non-linguistic and para-linguistic information labels among N Labelₘₐₓ(n).

### Effects

With the above configuration, the non-linguistic and para-linguistic information label is estimated for each listener with high accuracy without changing the determination criteria, and estimation results thereof are integrated, making it possible for the recognition apparatus according to the present embodiment to estimate the non-linguistic and para-linguistic information as the recognition apparatus with higher accuracy than the related art.

### Second Embodiment

The description will focus on parts different from those in the first embodiment.

In the present embodiment, the training of the non-linguistic and para-linguistic information classification model for each listener is not performed individually, but the non-linguistic and para-linguistic information label of each listener can be estimated using a single non-linguistic and para-linguistic information classification model.

In the field of speech recognition or speech synthesis, a scheme of inputting a speaker code to the classification model based on deep learning has been proposed in order to perform speech recognition and speech synthesis according to the speaker (see Reference 2).

### (Reference 2) Yosuke Kashiwagi, Daisuke Saito, Nobuaki Minematsu, Keikichi Hirose, “Adaptation of Neural Network Acoustic Model Using Speaker Normalization Learning Based on Speaker Code”, Technical Report 114 (365), pp. 105-110, 2014.

Similar to the above approach, a listener code that is information indicating the listener is prepared and a listener code is input to the classification model based on deep learning, making it possible to acquire non-linguistic and para-linguistic information label estimation results from listener 1 to listener N from a single non-linguistic and para-linguistic information classification model.

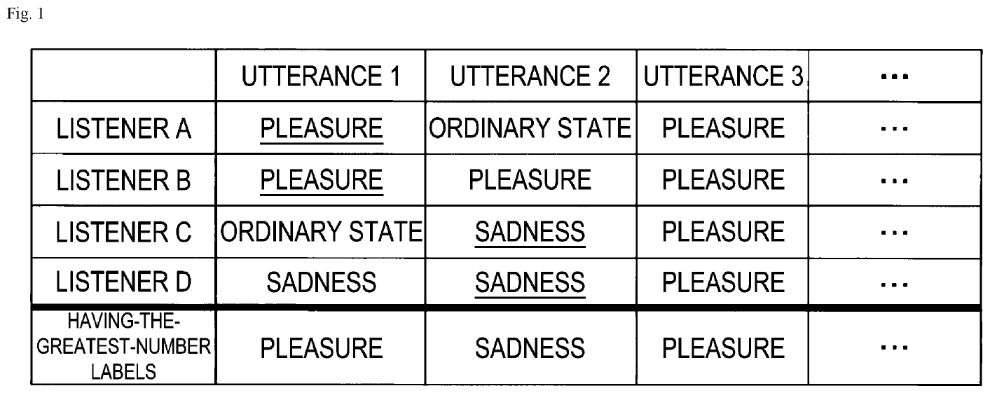

Preparing a single classification model instead of preparing a separate classification model for each listener is equivalent to sharing a part of the classification model. Thus, it can be expected that the recognition accuracy of a non-linguistic and para-linguistic information label (for example, utterance 3 in FIG. 1) that is determined regardless of a listener will be improved.

The non-linguistic and para-linguistic information recognition system of the present embodiment includes a training apparatus 300 and a recognition apparatus 400.

The training apparatus 300 receives a combination of the training input utterance data and the non-linguistic and para-linguistic information label (correct answer label) for each listener corresponding to the training input utterance data as an input, trains one non-linguistic and para-linguistic information classification model, and outputs a result. In the present embodiment, the training apparatus 300 prepares a listener code corresponding to the non-linguistic and para-linguistic information label for each listener, and uses the training input utterance data, and a combination of the non-linguistic and para-linguistic information label (correct answer label) for each listener corresponding to the training input utterance data and the listener code, for training of the non-linguistic and para-linguistic information classification model.

The recognition apparatus 400 receives one non-linguistic and para-linguistic information classification model prior to the recognition processing. The recognition apparatus 400 receives the input utterance data to be recognized as an input, estimates the non-linguistic and para-linguistic information label as the recognition apparatus 400 using the non-linguistic and para-linguistic information classification model, and outputs an estimation result.

First, the training apparatus 300 will be described.

### Training Apparatus 300

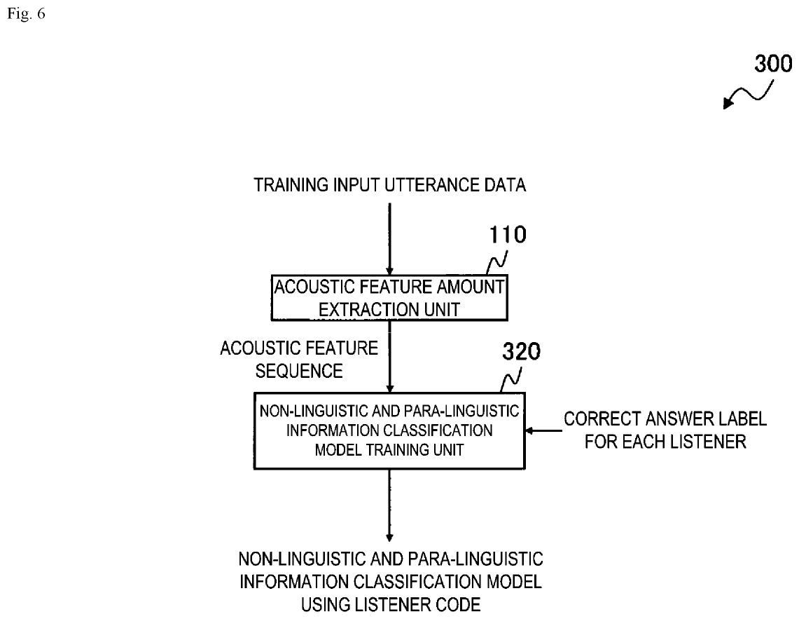

FIG. 6 illustrates a functional block diagram of the training apparatus 300 according to the second embodiment, and FIG. 3 illustrates a processing flow thereof.

The training apparatus 300 includes an acoustic feature amount extraction unit 110, and a non-linguistic and para-linguistic information classification model training unit 320.

### Non-linguistic and Para-linguistic Information Classification Model Training Unit 320

Input: Acoustic feature sequence, non-linguistic and para-linguistic information label of listener 1, . . . , non-linguistic and para-linguistic information label of listener N (correct answer label)
Output: Non-linguistic and para-linguistic information classification model using listener code

The non-linguistic and para-linguistic information classification model training unit 320 sets the acoustic feature sequence of the training input utterance data, the non-linguistic and para-linguistic information label (correct answer label) imparted to the training input utterance data by listeners 1, 2, . . . , N, and the listener code as training data, and trains the para-linguistic information classification model using the listener code (S320). The para-linguistic information classification model using the listener code is a model for estimating a non-linguistic and para-linguistic information label to be imparted to the utterance data by the listener corresponding to the listener code from the acoustic feature sequence corresponding to the utterance data and the listener code.

In the training of the present model, collection of a large number of sets of an acoustic feature sequence of a certain utterance and non-linguistic and para-linguistic information label of listeners 1, . . . , listener N corresponding to the utterance is used. A para-linguistic information classification model using the listener code is trained using the following procedure.

(1) The non-linguistic and para-linguistic information classification model training unit 320 randomly selects an acoustic feature sequence corresponding to a certain training input utterance data from a large number of acoustic feature sequences corresponding to a large amount of training input utterance data, and selects the non-linguistic and para-linguistic information label of the acoustic feature sequence and the listener n of the utterance. Here, n is randomly selected from 1 to N.

(2) The non-linguistic and para-linguistic information classification model training unit 320 prepares the listener code of listener n. For example, the listener code of listener n is a vector (1-hot vector) in which a vector length is N and only an n-th element is 1.

(3) The non-linguistic and para-linguistic information classification model training unit 320 repeats the above-described (1) and (2), and prepares a set of an acoustic feature sequence, a random listener's non-linguistic and para-linguistic information label, and a listener code, for several utterances.

(4) The non-linguistic and para-linguistic information classification model training unit 320 uses a combination of the acoustic feature sequence of (3) described above, the listener code, and the non-linguistic and para-linguistic information label corresponding to the listener code to set the non-linguistic and para-linguistic information label corresponding to the listener code as a instructor label, and performs updating of model parameters of the non-linguistic and para-linguistic information classification model using the listener code. In updating of the parameters, a cross entropy between the instructor label and a classification model output is used as a loss function, and a stochastic gradient descent method is used while applying an error back propagation method to the loss function.

(5) When the non-linguistic and para-linguistic information classification model training unit 320 repeats the above-described steps (3) and (4) and performs a sufficient number of times (for example, 100000 times) of parameter updating, the non-linguistic and para-linguistic information classification model training unit 320 regards the training as having been completed, and outputs the para-linguistic information classification model using the listener code.

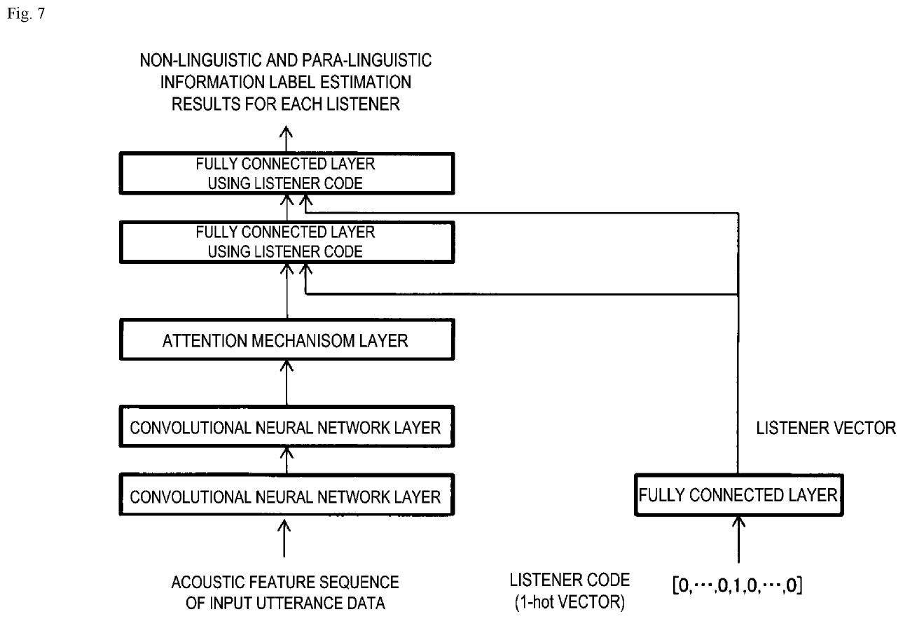

Further, in the present embodiment, for the para-linguistic information classification model using the listener code, a structure illustrated in FIG. 7 is used. That is, this is the same as a model structure of the related art except for the fully connected layer. The listener code can be used for the fully connected layer in the present embodiment. A method of calculating an output y of the fully connected layer using the listener code is as follows.

y=σ(Wx+b+Bc)

y: Output of fully connected layer using listener code.
x: Input of fully connected layer using a listener code (output of a previous layer).
c: Listener vector (an output when the listener code is input to the fully connected layer).
σ(⋅): Activation function. Although sigmoid is used in the present embodiment, other activation functions may be used.
W: Linear transformation parameters of the input and output of the fully connected layers using the listener code (acquired by training).
b: Bias parameters of the input and output of the fully connected layers using the listener code (acquired by training).
B: Listener code linear transformation parameter (acquired by training).

### Recognition Apparatus 400

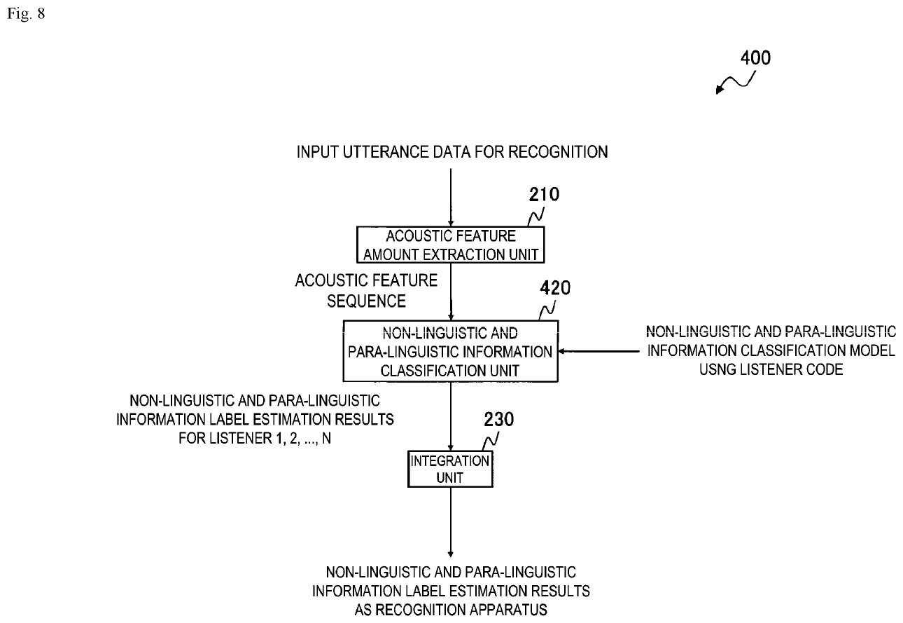

FIG. 8 illustrates a functional block diagram of the recognition apparatus 200 according to the first embodiment, and FIG. 5 illustrates a processing flow thereof.

The recognition apparatus 400 includes an acoustic feature amount extraction unit 210, a non-linguistic and para-linguistic information classification unit 420, and an estimation result integration unit 230.

The recognition apparatus 400 inputs the input utterance data to be recognized to one non-linguistic and para-linguistic information classification model trained by the training apparatus 100, and obtains the non-linguistic and para-linguistic information recognition results for each listener.

Then, the recognition apparatus 400 integrates the non-linguistic and para-linguistic information recognition results for respective listeners, and obtains the non-linguistic and para-linguistic information recognition results as the recognition apparatus 400.

Hereinafter, the non-linguistic and para-linguistic information classification unit 420 different from that in the first embodiment will be described.

### Non-linguistic and Para-linguistic Information Classification Unit 420

Input: Acoustic feature sequence, and non-linguistic and para-linguistic information classification model using listener code
Output: Non-linguistic and para-linguistic information label estimation result of listener n (n=1, 2, . . . , N)

The non-linguistic and para-linguistic information classification unit 420 prepares the listener code of listener n.

The non-linguistic and para-linguistic information classification unit 420 estimates the non-linguistic and para-linguistic information label imparted by the listener n (n=1, 2, . . . , N) from the acoustic feature sequence of the input utterance data to be recognized using the non-linguistic and para-linguistic information classification model using the listener code, from the acoustic feature sequence and the listener code (S420). The non-linguistic and para-linguistic information label estimation results of listener n includes a posterior probability for each non-linguistic and para-linguistic information label obtained by inputting the acoustic feature sequence and the listener code of listener n to the non-linguistic and para-linguistic information classification model using the listener code and propagating these forward. In this case, the listener code of listener n is the same as the listener code used at the time of training in the non-linguistic and para-linguistic information classification model training unit 320 and is, for example, a vector (1-hot vector) in which a vector length is N and only an n-th element is 1.

### Effects

With such a configuration, it is possible to obtain the same effects as those of the first embodiment. Further, it can be expected that the recognition accuracy of a non-linguistic and para-linguistic information label that is determined regardless of a listener will be improved.

### Other Modification Example

The present disclosure is not limited to the embodiment and modification example. For example, the various processing described above may not only be executed in chronological order according to the description, but may also be executed in parallel or individually according to processing capacity of a device that executes the processing or as necessary. In addition, change can be made appropriately without departing from the spirit of the present disclosure.

### Program and Recording Medium

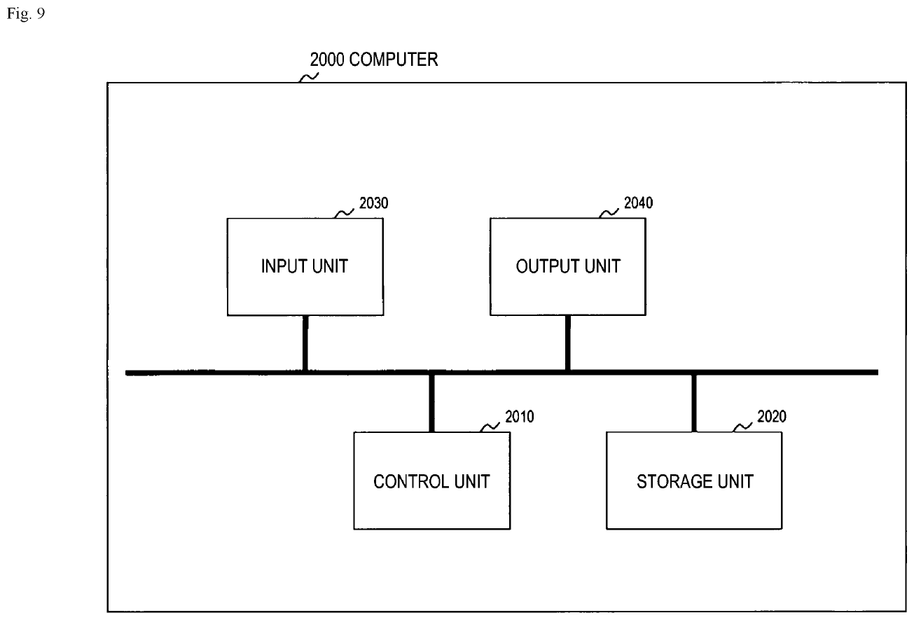

The various processing described above can be performed by causing a program for executing each step of the above method to be loaded into a storage unit 2020 of a computer illustrated in FIG. 9 and causing the program to be operated in a control unit 2010, an input unit 2030, an output unit 2040, and the like.

A program in which processing content thereof has been described can be recorded on a computer-readable recording medium. The computer-readable recording medium may be, for example, a magnetic recording device, an optical disc, a magneto-optical recording medium, or a semiconductor memory.

Further, distribution of this program is performed, for example, by selling, transferring, or renting a portable recording medium such as a DVD or CD-ROM on which the program has been recorded. Further, the program may be distributed by being stored in a storage device of a server computer and transferred from the server computer to another computer via a network.

The computer that executes such a program first temporarily stores, for example, the program recorded on the portable recording medium or the program transferred from the server computer in a storage device of the computer. When the computer executes the processing, the computer reads the program stored in the recording medium of the computer and executes processing according to the read program. Further, as another embodiment of the program, the computer may directly read the program from the portable recording medium and execute the processing according to the program, and further, processing according to a received program may be sequentially executed each time the program is transferred from the server computer to the computer. Further, a configuration in which the above-described processing is executed by a so-called application service provider (ASP) type service for realizing a processing function according to only an execution instruction and result acquisition without transferring the program from the server computer to the computer may be adopted. It is assumed that the program in the present embodiment includes information provided for processing of an electronic calculator and being pursuant to the program (such as data that is not a direct command to the computer, but has properties defining processing of the computer).

Further, in this embodiment, although the present device is configured by a predetermined program being executed on the computer, at least a part of processing content of thereof may be realized by hardware.

1. A recognition apparatus comprising a processor configured to execute a method comprising:
estimating a non-linguistic and para-linguistic information label to be imparted by an n-th listener from an acoustic feature amount of speech data to be recognized using an n-th classification model, and n=1, 2, . . . , N;
integrating estimation results of the non-linguistic and para-linguistic information labels for N listeners; and
obtaining non-linguistic and para-linguistic information estimation results as a recognition apparatus for the speech data to be recognized,
wherein the n-th classification model is a classification model trained using training speech data and a non-linguistic and para-linguistic information label imparted to the training speech data by the n-th listener as training data.

2. A recognition apparatus comprising a processor configured to execute a method comprising:
estimating a non-linguistic and para-linguistic information label to be imparted by an n-th listener from a listener code indicating the n-th listener and an acoustic feature amount of speech data to be recognized using a classification model, for n=1, 2, . . . , N;
integrating estimation results of the non-linguistic and para-linguistic information labels for N listeners; and
obtaining non-linguistic and para-linguistic information estimation results as a recognition apparatus for the speech data to be recognized,
wherein the n-th classification model is a classification model trained using training speech data, the listener code indicating the n-th listener, and a non-linguistic and para-linguistic information label imparted to the training speech data by the n-th listener as training data.

3. A training apparatus comprising a processor configured to execute a method comprising:
training a para-linguistic information classification model using a listener code from an acoustic feature sequence of training speech data, a non-linguistic and para-linguistic information label imparted to the training speech data by a listener n, and the listener code being information indicating the listener n,
wherein the para-linguistic information classification model using the listener code is a model for estimating a non-linguistic and para-linguistic information label to be imparted to the speech data by the listener corresponding to the listener code from the acoustic feature sequence corresponding to the speech data and the listener code.

4-7. (canceled)

8. The recognition apparatus according to claim 1, wherein the acoustic feature amount is associated with an acoustic feature including at least one of: a logarithmic power spectrum, a logarithmic filter bank, a Mel-Frequency Cepstral Coefficient, a fundamental frequency, a logarithmic power, a harmonics-to-noise ratio, a speech probability, or a number of zero intersections.

9. The recognition apparatus according to claim 1, wherein the classification model is based on deep learning including a time-series model layer and a fully connected layer, and the time-series model layer includes a combination of a convolutional neural network layer and a self-attention mechanism layer.

10. The recognition apparatus according to claim 2, wherein the acoustic feature amount is associated with an acoustic feature including at least one of: a logarithmic power spectrum, a logarithmic filter bank, a Mel-Frequency Cepstral Coefficient, a fundamental frequency, a logarithmic power, a harmonics-to-noise ratio, a speech probability, or a number of zero intersections.

11. The recognition apparatus according to claim 2, wherein the classification model is based on deep learning including a time-series model layer and a fully connected layer, and the time-series model layer includes a combination of a convolutional neural network layer and a self-attention mechanism layer.

12. The training apparatus according to claim 3, wherein the acoustic feature sequence is associated with an acoustic feature including at least one of: a logarithmic power spectrum, a logarithmic filter bank, a Mel-Frequency Cepstral Coefficient, a fundamental frequency, a logarithmic power, a harmonics-to-noise ratio, a speech probability, or a number of zero intersections.

13. The training apparatus according to claim 3, wherein the model is based on deep learning including a time-series model layer and a fully connected layer, and the time-series model layer includes a combination of a convolutional neural network layer and a self-attention mechanism layer.
